(19) United States
(12) Patent Application Publication
(10) Pub. No.: US 2015/0342832 A1
(43) Pub. Date: Dec. 3, 2015

(54) LIQUID NUTRITION BOTTLE

(71) Applicant: ABBOTT LABORATORIES, Abbott Park, IL (US)

(72) Inventors: CHRISTOPHER COX, Westerville, OH (US); MICHAEL LORENZ, Gahanna, OH (US); SHARI LEE MORSE, Temperance, MI (US)

(73) Assignee: ABBOTT LABORATORIES, Abbott Park, IL (US)

(21) Appl. No.: 14/654,246

(22) PCT Filed: Dec. 20, 2013
(86) PCT No.: PCT/US2013/077078

§ 371 Date: Jun. 19, 2015

Related U.S. Application Data
(60) Provisional application No. 61/745,062, filed on Dec. 21, 2012.

(51) Int. Cl. A61J 9/00

(52) U.S. Cl. CPC A61J 9/00

(57) ABSTRACT

A bottle for storing liquid nutrition and feeding liquid nutrition to an infant. The bottle includes a base portion, a neck portion for removably securing a cap or nipple, and a body portion disposed between the base portion and the neck portion. A rib protrudes from an outer surface of the bottle and is arranged for manual gripping by a user to manipulate a position of the bottle relative the infant. The outer surface of the bottle may include at least two remote and distinct outer surface areas which each define a cylindrical section of the bottle. Each surface area may be positioned for engagement by machinery during a filling operation.

### CROSS-REFERENCE TO RELATED APPLICATIONS

This application claims priority to and any benefit of U.S. Provisional Application No. 61/745,062, filed Dec. 21, 2012, the entire contents of which are incorporated by reference in its entirety.

### BACKGROUND

A parent, hospital employee or caregiver of an infant may elect to use a bottle as a primary or supplemental device for supplying nutrition to the infant. Feeding the infant typically requires two arms, one arm to hold and comfort the infant, and one arm to hold and manipulate the bottle. Initially, or at times during feeding, the infant may grow restless or become uncomfortable. The parent or caregiver may often need to adjust the position of the baby or the bottle, or both, in order to complete a successful feeding.

Bottles used for feeding an infant may be filled by a variety of known methods. For example, a mother may pump breast milk to fill a bottle or a parent may fill a bottle using a larger container of infant formula. Also, a bottle made be filled with formula at a production facility. Bottles of this type are preferably suitable for high-speed filling and sealing production lines.

### SUMMARY

The present application describes a bottle for storing liquid nutrition and feeding liquid nutrition to an infant.

In an exemplary embodiment, a bottle for storing liquid nutrition and feeding liquid nutrition to an infant. The bottle includes a base portion, a neck portion for removably securing a cap or nipple, and a body portion disposed between the base portion and the neck portion. A rib protrudes from an outer surface of the bottle and is arranged for manual gripping by a user to manipulate a position of the bottle relative the infant. The bottle may include at least two remote and distinct outer surface areas which each define a cylindrical section of the bottle. Each surface area may be positioned for engagement by machinery during filling and sealing operations.

### BRIEF DESCRIPTION OF THE DRAWINGS

Features and advantages of the general inventive concepts will become apparent from the following detailed description made with reference to the accompanying drawings.

FIG. 1 is a front view of an exemplary bottle, showing a rib protruding from an outer surface of the bottle;

FIG. 2 is a front view of another exemplary bottle;

FIG. 3 is a front view of another exemplary bottle; and

FIG. 4 is a front perspective view of the bottle of FIG. 1, shown with a nipple installed on the bottle and held in an application position by a user.

### DETAILED DESCRIPTION

This Detailed Description merely describes exemplary embodiments in accordance with the general inventive concepts and is not intended to limit the scope of the invention or the claims in any way. Indeed, the invention as described by the claims is broader than and unlimited by the exemplary embodiments set forth herein, and the terms used in the claims have their full ordinary meaning.

The general inventive concepts will now be described with occasional reference to the exemplary embodiments of the invention. This general inventive concept may, however, be embodied in different forms and should not be construed as limited to the embodiments set forth herein. Rather, these embodiments are provided so that this disclosure will be thorough and complete, and will fully convey the scope of the general inventive concepts to those skilled in the art.

Unless otherwise defined, all technical and scientific terms used herein have the same meaning as commonly understood by one of ordinary skill in the art encompassing the general inventive concepts. The terminology set forth in this detailed description is for describing particular embodiments only and is not intended to be limiting of the general inventive concepts. As used in this detailed description and the appended claims, the singular forms “a,” “an,” and “the” are intended to include the plural forms as well, unless the context clearly indicates otherwise.

Unless otherwise indicated, all numbers expressing quantities of ingredients, properties such as molecular pressure source, reaction conditions, and so forth as used in the specification and claims are to be understood as being modified in all instances by the term “about.” Accordingly, unless otherwise indicated, the numerical properties set forth in the specification and claims are approximations that may vary depending on the suitable properties sought to be obtained in embodiments of the present invention. Notwithstanding that the numerical ranges and parameters setting forth the broad scope of the general inventive concepts are approximations, the numerical values set forth in the specific examples are reported as precisely as possible. Any numerical values, however, inherently contain certain errors necessarily resulting from error found in their respective measurements.

The present application describes, in part, a bottle for storing liquid nutrition and feeding liquid nutrition to an infant. The bottle has physical features to promote control of the bottle by a user when feeding the infant. For example, the outer surface of the bottle is advantageously shaped for ease of manual gripping by a user to manipulate a position of the bottle relative the infant, such as for example, moving the bottle closer or farther away from the infant, or rotating the bottle clockwise or counterclockwise with respect to the infant.

An exemplary bottle includes a base portion, a neck portion and a body portion disposed between the neck portion and the body portion. The body portion may be narrower in outer diameter than other portions of the body. The base portion has a flat bottom for resting the bottle on a flat surface while in storage or during a break in use of the bottle. The neck portion is suitable for removably securing a cap to the bottle during storage or securing a nipple to the bottle during use. A rib may protrude from an outer surface of the bottle. The rib is arranged for manual gripping by a user to manipulate a position of the bottle relative the infant, such as for example, moving the bottle closer or farther away from the infant, or rotating the bottle clockwise or counterclockwise with respect to the infant.

An exemplary bottle may be suitable for engagement by machinery during a filling operation, such as for example, during a high speed aseptic filling and sealing production line. For example, an exemplary bottle may include at least two remote and distinct outer surface areas of the bottle which each define a cylindrical section of the bottle, i.e., a section of constant outer diameter relative to the longitudinal axis of the bottle.

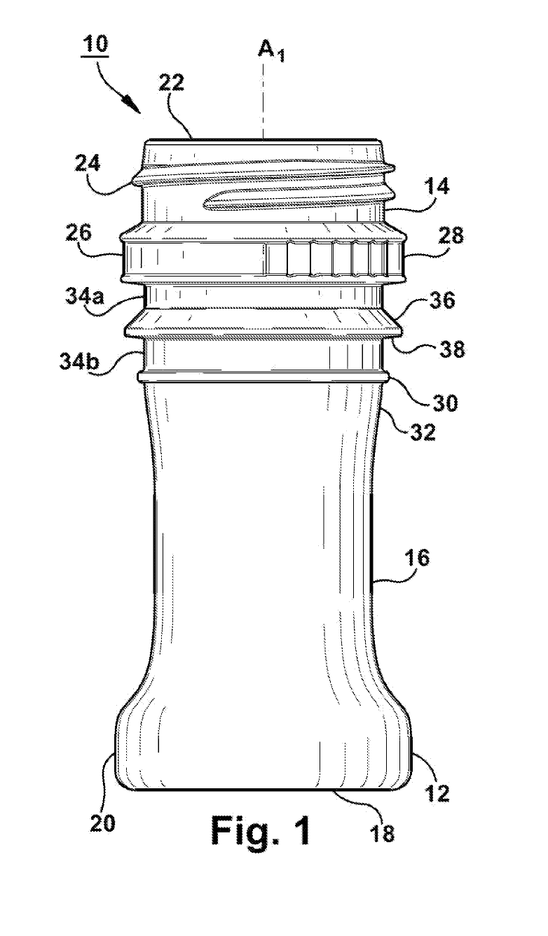

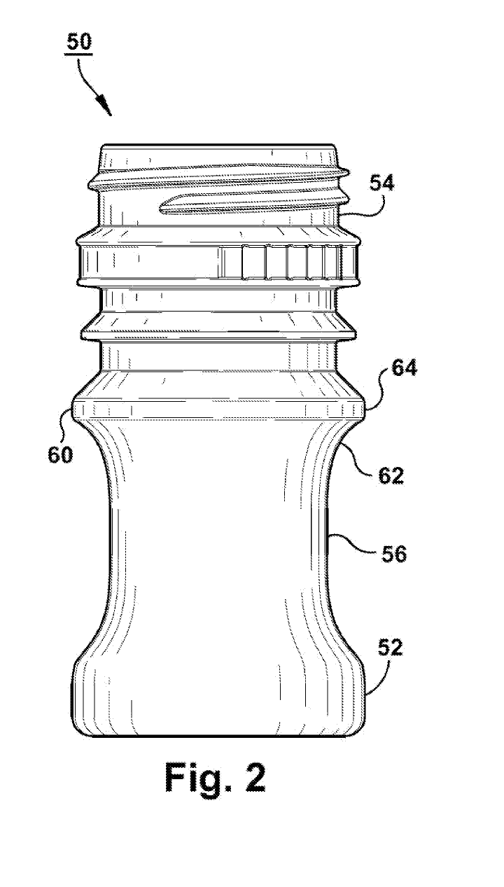

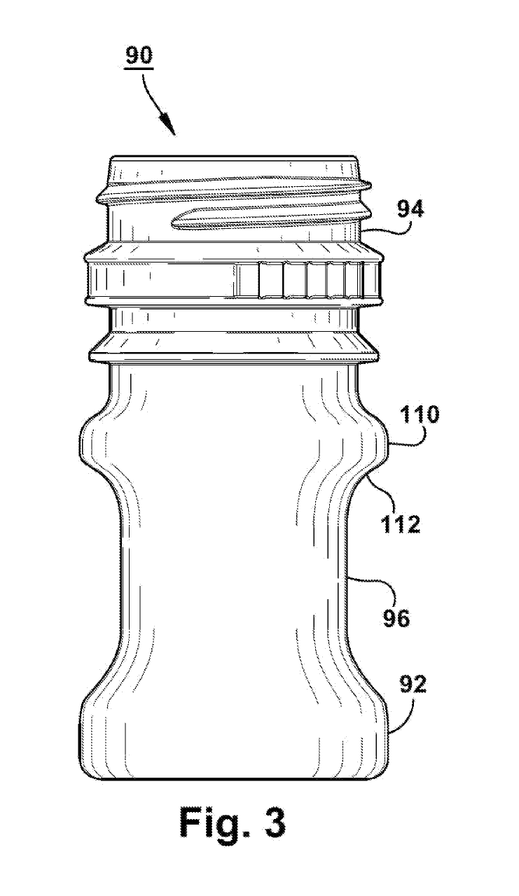

Referring now to the drawings, an exemplary embodiment of a bottle 10 for storing liquid nutrition and feeding liquid nutrition to an infant is shown in FIG. 1. The front view of FIG. 1 shows the bottle 10 in an upright orientation typical for storage in inventory, or for resting the bottle during a short break in use of the bottle. Other embodiments of the bottle 50, 90 are shown in FIGS. 2 and 3, respectively.

Referring again to FIG. 1, the exemplary bottle 10 includes a base portion 12, a neck portion 14 and a body portion 16. As shown, the body portion 16 is disposed between the base portion 12 and the neck portion 14. The body portion has a narrow outer diameter as compared to the rest of the bottle 10, and is the longest portion of the three portions 12, 14, 16. It should be apparent that other bottle shapes, and other shapes of bottle portions, can be utilized in the practice of this invention, and the scope of the invention is not intended to be limited by any of the three exemplary bottles 10, 50, 80 in FIGS. 1-3.

The base portion 12 shown has a flat bottom surface 18 and an outer flange 20. The flange 20 has a diameter larger than the diameter of the body portion 16. The exemplary shape lowers the center of gravity of the bottle 10, as compared to a bottle in which the base portion 12 has the same diameter as the body portion 16. Other base portion shapes and sizes can be utilized in the practice of this invention.

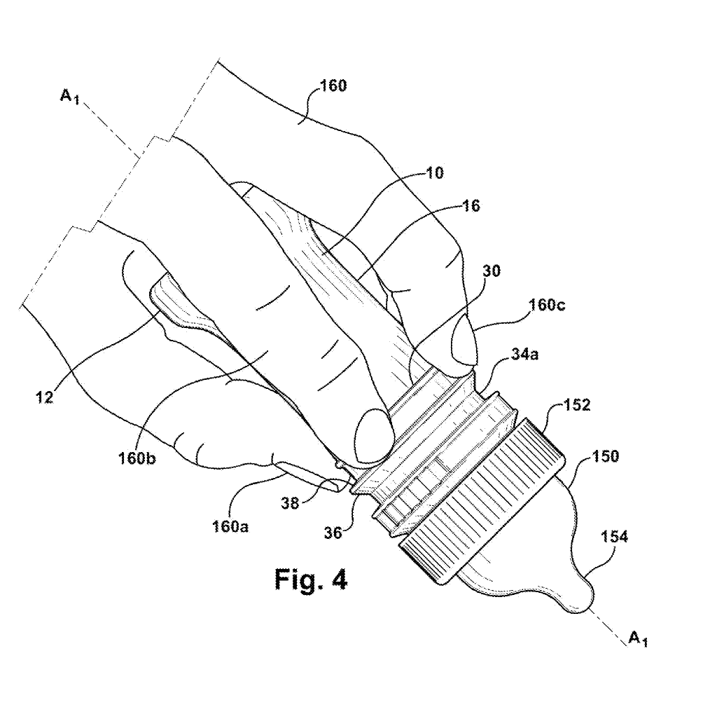

The neck portion 14 of the exemplary bottle 10 is suitable for multiple functions. For example, the neck portion 14 has an open end 22 permitting the bottle 10 to be manually or automatically filled. After filling, threads 24 on an outer surface of the neck portion 14 allow a cap (not shown) to be removably secured after filling, or replaced after a bottle has been partially used. The threads 24 also allow a nipple 150 to be removably secured (see FIG. 4) prior to feeding an infant. Other known structure for the neck suitable for attachment of a cap or a nipple may be utilized in the practice of this invention.

The neck portion 14 further includes features which are advantageous to high-speed filling and sealing production lines. For example, the neck portion 14 includes a cap-engaging rim portion 26. The cap-engaging rim portion 26 defines a cylindrical section of the bottle, i.e., a section of constant diameter relative to the longitudinal axis A₁ of the bottle 10. As shown in FIG. 1, a ratcheted section 28 is disposed around a portion of the outer circumference of the cap-engaging rim portion 26. In the practice of the invention, the cap-engaging rim portion could be longer or shorter along the longitudinal axis A₁ of the bottle 10, or the bottle could not include such a portion, or the ratcheted section 28 could be longer or shorter around the outer circumference of the cap-engaging rim portion, or the cap-engaging rim portion could not include such a section. The cap-engaging rim portion could also be shorter or higher as compared to the outer surface of the bottle. Likewise, the teeth of the ratchet section could also be shorter or higher as compared to the outer surface of the bottle.

As discussed herein, the outer surface of the bottle is arranged for manual gripping by a user to manipulate a position of the bottle. For example, the outer surface of the bottle promotes ease of movement of the bottle closer or farther away from the infant, or ease of rotation of the bottle clockwise or counterclockwise with respect to the infant. Further, the outer surface of the bottle may allow for fingertip control of the position of the bottle by allowing manual gripping, and at the same time, providing a predetermined location for the user to place one or more fingers (see FIG. 4).

The exemplary bottle 10 shown in FIGS. 1 and 3 includes a rib 30 protruding from the outer surface of the bottle. The rib 30 as shown is disposed in the top half of the bottle 10. Specifically, the rib 30 is disposed on the body portion 16 of the bottle 10, and more specifically, the rib is disposed in the top half of the body portion 16. The rib may be of another shape than illustrated in FIG. 1, such as for example, the rib 60 shown in FIG. 2 or the rib 110 shown in FIG. 3. The illustrated ribs 30, 60, 110 are shown for example only, and the present invention may be practiced with bottles having ribs of different size, shape and location.

The exemplary bottle 10 of FIG. 1 includes another feature advantageous for used manual control. The body portion 16 defines a flared portion 32 expanding in outer diameter toward the rib 30, i.e., in a direction from the base portion 12 to the neck portion 14. Discussed herein, the flange portion 32 offers increased fingertip control of the position of the bottle 10. As shown, the flared portion 32 is contiguous with the rib 30. The flange portion 32 may be relatively subtle is shape, as in FIG. 1, or may be more distinct, such as for example, the flange portions 62, 112, as shown in FIGS. 2 and 3, respectively. The illustrated flange portions 32, 62, 112 are shown for example only, and the invention may be practiced with bottles having flange portions of different size, shape and location, or with a bottle with more than one flange portion, or a bottle with no flange portion.

As discussed herein, a rib of various shapes may be utilized in the practice of this invention. For example, a rib may define a cylindrical section of the bottle, such as in FIG. 2. The cylindrical section 64 of the bottle 50 has a constant outer diameter relative to the longitudinal axis of the bottle. A bottle of this invention may have a cylindrical shaped rim, or a rim with rounded edges, such as the illustrated rims 30, 110 of FIGS. 1 and 3, respectively.

The exemplary bottle 10 is shaped and sized for ease of production on a filling operation. For example, the bottle is adequately shaped and sized for use on a high speed aseptic filling and sealing production line. For example, the bottle 10 includes at least two remote and distinct outer surface areas 34a, 34b. Each of the surface areas 34a, 34b defines a cylindrical section of the bottle and each surface areas 34a, 34b is positioned for engagement by machinery during a filling operation. For example, as a bottle is transported done a rotary fill line, a control arm grips the upper area 34a as an upstream releases the lower area 34b. At the next transition station, a downstream control arm grips the free lower area 34b, as the previous control arm releases the lower area 34a. The bottle 10 continues through the production line in this repetitive handoff pattern. As shown in FIG. 1, an intermediate tapered portion 36 separates the two remote surface areas 34a, 34b. Other exemplary bottles 50, 90 each include at least two remote and distinct outer surface areas and an intermediate tapered portion. It is apparent the present invention can be practiced without these features, or with at least two remote and distinct outer surface areas and an intermediate tapered portion having a different size, shape or location on the bottle.

As shown in the exemplary bottle 10, the rib 30 is placed near the top of the body portion 16. Specifically, the rib 30 is disposed contiguous to a lowermost 34b of the at least two remote and distinct outer surface areas. As such, a shoulder 38 of the intermediate portion 36 offers an anchoring point for finger travel in a direction toward the neck portion 12 of the bottle 10, as a shown in FIG. 4. This location of the rib 30 is for example only, and other locations for the rib may be utilized in the practice of the invention.

As discussed herein, other exemplary bottles 50, 90 are shown in FIGS. 2 and 3. Each bottle shares similarities to the bottle 10 of FIG. 1. However, examples of different shapes and sizes of base portions 52, 92, neck portions 54, 94, and body portions 56, 96 are shown in FIGS. 2 and 3, respectively.

Use of an exemplary bottle will now be discussed. FIG. 4 is a front perspective view of the bottle 10 of FIG. 1 being held by one hand of a user. Specifically, the bottle 10 is shown with a nipple 150 installed on the bottle and held in an application position by a user in preparation of feeding an infant (not shown). The nipple has a tip 154 and a ring base 152 threaded onto the neck portion of the bottle. The ring base 152 is engaged with the threads 24 (not shown) on the outer surface of the neck portion 14. In this position, the position of the bottle 10 may be manually adjusted by the hand 160 of the user.

The shape of the bottle 10 offers fingertip control by the user. As shown, the user has manually gripped the bottle 10. The thumb 160a of the user has rested upon the rib 30, the index finger of the user has rested upon the rim 30, and movement of the index finger toward the nipple 150 has stopped at the shoulder 38. The middle finger 160c of the user is in a similar position as the index finger 160b. With the hand 160 of the user in the exemplary position shown, the user can manipulate a position of the bottle relative the infant with ease, such as for example, moving the bottle closer or farther away from the infant, or rotating the bottle clockwise or counterclockwise about the longitudinal axis A₁ of the bottle and with respect to the infant. In the use of an exemplary bottle, a hand of a user may be placed in an alternative locations, as can one or more fingers of a user be placed in an alternative location.

While various inventive aspects, concepts and features of the general inventive concepts are described and illustrated herein in the context of various exemplary embodiments, these various aspects, concepts and features may be used in many alternative embodiments, either individually or in various combinations and sub-combinations thereof. Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, circuits, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

1-20. (canceled)

21. A bottle for storing liquid nutrition and feeding liquid nutrition to an infant, the bottle comprising:
a base portion, a neck portion for removably securing a cap or nipple, and a body portion disposed between the base portion and the neck portion; and
a rib protruding from an outer surface of the bottle and arranged for manual gripping by a user to manipulate a position of the bottle relative the infant;
wherein at least two remote and distinct outer surface areas of the bottle each define a cylindrical section of the bottle and each are positioned for engagement by machinery during a filling operation;
wherein the rib is disposed below the lowermost of the at least two remote and distinct outer surface areas of the bottle.

22. The bottle of claim 21, wherein the rib is disposed in the top half of the bottle.

23. The bottle of claim 21, wherein the rib is disposed in the body portion of the bottle.

24. The bottle of claim 23, wherein the rib is disposed in the top half of the body portion.

25. The bottle of claim 21, wherein the body portion defines a flared portion expanding in outer diameter toward the rib.

26. The bottle of claim 25, wherein the flared portion is contiguous with the rib.

27. The bottle of claim 21, wherein the rib is disposed contiguous to a lowermost of the at least two remote and distinct outer surface areas of the bottle.

28. The bottle of claim 21, wherein the rib defines a cylindrical section of the bottle.

29. The bottle of claim 21, wherein the neck comprises a cap-engaging rim portion, the cap-engaging rim portion defining a cylindrical section of the bottle.

30. The bottle of claim 29, wherein a ratcheted section is disposed around at least a portion of the outer circumference of the cap-engaging rim portion.

31. A bottle for storing liquid nutrition and feeding liquid nutrition to an infant, the bottle comprising:
a base portion, a neck portion for removably securing a cap or nipple, and a body portion disposed between the base portion and the neck portion; and
a rib protruding from an outer surface of the bottle and arranged for manual gripping by a user to manipulate a position of the bottle relative the infant;
wherein the body portion defines a flared portion expanding in outer diameter toward the rib, wherein the rib is located contiguous to and below the flared portion.

32. The bottle of claim 31, wherein at least two remote and distinct outer surface areas of the bottle each define a cylindrical section of the bottle and each are positioned for engagement by machinery during a filling operation.

33. The bottle of claim 31, wherein the rib is disposed contiguous to a lowermost of the at least two remote and distinct outer surface areas of the bottle.

34. The bottle of claim 31, wherein the rib defines a cylindrical section of the bottle.

35. A bottle for storing liquid nutrition and feeding liquid nutrition to an infant, the bottle comprising:
a base portion, a neck portion for removably securing a cap or nipple, and a body portion disposed between the base portion and the neck portion; and
a rib disposed on the body portion and protruding from an outer surface of the bottle and arranged for manual gripping by a user to manipulate a position of the bottle relative the infant;
wherein the body portion defines a flared portion expanding in outer diameter toward and contiguous with the rib;
wherein the neck comprises a cap-engaging rim portion and a ratcheted section, the cap-engaging rim portion defining a cylindrical section of the bottle, and the ratcheted section disposed around at least a portion of the outer circumference of the cap-engaging rim portion.

36. The bottle of claim 35, wherein at least two remote and distinct outer surface areas of the bottle each define a cylindrical section of the bottle and each are positioned for engagement by machinery during a filling operation.

37. The bottle of claim 35, wherein the rib is disposed contiguous to a lowermost of the at least two remote and distinct outer surface areas of the bottle.
